(19) United States
(12) Patent Application Publication
(10) Pub. No.: US 2019/0183065 A1
(43) Pub. Date: Jun. 20, 2019

(54) SELF-WATERING PLANTER WITH REMOVABLE RISER

(71) Applicant: Classic Home and Garden, LLC, Monroe, NY (US)

(72) Inventor: Fred Joseph Ryan, Trumbull, CT (US)

(21) Appl. No.: 15/848,732

(22) Filed: Dec. 20, 2017

(51) Int. Cl. A01G 9/02

(52) U.S. Cl. CPC A01G 9/028

(57) ABSTRACT

A planter includes a base including a raised portion to form a channel beneath the base. At least one substantially vertical planter sidewall is formed with the base. At least one drain post is integrally formed on the base and extending substantially vertically upwards with a drain opening at the top of each of the at least one drain post in communication with the channel. The planter includes a removable riser. The removable riser includes a plate supported by a plurality of hollow support columns wherein the hollow support columns are longer than the at least one drain post forming a reservoir beneath the plate. The hollow support columns each include at least one opening in a column sidewall.

### BACKGROUND

### Technical Field

The present invention relates to planters, and more particularly to planters having a riser platform insertable into the planter to support a plant above a reservoir of water.

### Description of the Related Art

Watering plants often requires a precise volume of water to ensure that the plant is healthy. For example, providing too much water to a plan can result in oversaturated soil that can drown the plant, which can cause the plant to look wilted and discolored, and can even result in irreparable cell damage to leaves and petals. However, if the plant's soil is too dry, the plant will not have enough water to survive. Consequently, manually providing the correct amount of water to a particular plant may be a difficult and time consuming endeavor, requiring frequent small waterings.

In response to this watering problem, some planters may include a reservoir below the plant. This reservoir may serve to facilitate the draining of excess water from the soil such that the soil does not become over saturated. However, even in such planters, the reservoir can easily fill up, with the water level rising up into the soil above. This overflow of the reservoir results in saturating the plant soil, thus oversaturating the soil and drowning the plant. Moreover, many planters fail to provide a way for the plant to access the water in the reservoir. As a result, the water held in the reservoir goes unused. Therefore, a gardener is required to continually water the plant as water drains from the soil into the reservoir. As a result, there is a need for a self-watering planter that ensures that the plant and the soil are consistently maintained at a proper degree of soil saturation such that the soil does not become oversaturated or dry.

### SUMMARY

According to embodiments of the present invention, a self-water planter is described. The plant includes a base including a raised portion to form a channel beneath the base. At least one substantially vertical planter sidewall is formed with the base. At least one drain post is integrally formed on the base and extending substantially vertically upwards with a drain opening at the top of each of the at least one drain post in communication with the channel. The planter includes a removable riser. The removable riser includes a plate supported by a plurality of hollow support columns wherein the hollow support columns are longer than the at least one drain post forming a reservoir beneath the plate. The hollow support columns each include at least one opening in a column sidewall.

According to other embodiments, a self-watering stackable planter is described. A stackable planter includes a base including a raised portion to form a channel beneath the base. At least one substantially vertical planter sidewall formed with the base. A plurality of drain posts are integrally formed on the base and extending substantially vertically upwards with a drain opening at the top of each of the drain posts in communication with the channel. A plurality of projections extend upwardly from the base. The stackable planter further includes a removable riser, wherein the removable riser includes a plate supported by a plurality of hollow support columns. The hollow support columns are longer than the plurality of drain posts forming a reservoir beneath the plate. Each of the hollow support columns include a locator opening for mating contact with the plurality of projections. Each of the hollow support columns include a slit-like opening in a column sidewall.

According to embodiments of the present invention, a method for plant watering with a self-watering planter is described. The method includes providing a planter with a base including a raised portion to form a channel beneath the base. At least one substantially vertical planter sidewall is formed with the base. At least one drain post is integrally formed on the base and extending substantially vertically upwards with a drain opening at the top of each of the at least one drain post in communication with the channel. The planter includes a removable riser. The removable riser includes a plate supported by a plurality of hollow support columns wherein the hollow support columns are longer than the at least one drain post forming a reservoir beneath the plate. The hollow support columns each include at least one opening in a column sidewall. The method further includes supporting a plant and a soil mixture on a top portion of the removable riser and in the hollow support columns. The method further includes storing water in the reservoir such that the soil mixture in the plurality of hollow support columns absorbs the water and transports it by capillary action to the plant.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a side view of a planter in accordance with one embodiment;

FIG. 2A is a partial top view of the planter of FIG. 1 showing a planter with drain posts therein in accordance with one embodiment;

FIG. 2B is a cross-sectional view of the planter of FIG. 1 showing a planter with drain posts therein in accordance with one embodiment;

FIG. 2C is a cross-sectional view of the planter of FIG. 1 showing a planter with drain posts therein in accordance with another embodiment;

FIG. 3 is top isometric view of a removable riser that supports a plant in accordance with another embodiment;

FIG. 4 is a bottom isometric view of a removable riser that supports a plant in accordance with another embodiment;

FIG. 5 is a bottom view of a removable riser that supports a plant in accordance with another embodiment;

FIG. 6 is a partial cross-sectional schematic of a planter and a removable riser in accordance with another embodiment;

FIG. 7A is a partial top view a planter having a removable riser that supports a plant above a reservoir in accordance with another embodiment;

FIG. 7B is a magnified view illustrating a connection between the removable riser and the planter in accordance with illustrative embodiments;

FIG. 8A is a cross-sectional view of a planter with a removable riser in operation in accordance with illustrative embodiments; and

FIG. 8B is a cross-sectional view of a planter with a removable riser in operation in accordance with another illustrative embodiment.

### DETAILED DESCRIPTION

Disclosed herein are embodiments and aspect of an inventive self-watering planter having a removable riser insert. To ensure the proper amount of water is supplied to a potted plant, the removable riser insert may rest at the bottom of planter on support columns. The support columns of the riser ensure that the riser is a particular distance above the base of the planter, thus creating a reservoir below the riser for holding water. A plant with the appropriate soil mixture may then rest on the riser above the reservoir.

The support columns may be hollow with the soil mixture extending down into the columns. These support columns may then provide for contact between the water in the reservoir and the soil in the column, thus enabling water to be soaked up into the soil and into the plant roots through capillary action. Because the water is introduced to the root through capillary action of the soil, the amount of water consumed by the roots dictates the amount of water soaked up by the soil, thus ensuring that the roots only have as much water as the plant needs to be healthy. As a result, the planter is self-watering due to the capillary action of the soil providing water from the reservoir to the roots of the plant.

To prevent overwatering by overfilling the reservoir, thus saturating the soil mixture of the plant, drain posts may be located on the base of the planter. The drain posts may of such a height as to drain water through a drainage opening located at a height below the removable riser. Such a drain post ensures that if an excessive amount of water is introduced into the planter, the excess is removed before the water can saturate the soil and overwater the plant, which would otherwise cause discoloration, wilting, and even damage at the cellular level.

The planters in accordance with the present principles may be fabricated by molding processes using plastics; however, other materials are contemplated as well. For example, the planters may include metal construction, concrete, wood, etc. In one embodiment, the planters are a monolithic construction (e.g., one piece).

It is to be understood that the present invention will be described in terms of a given illustrative architectures; however, other architectures, structures, materials and process features and steps may be varied within the scope of the present invention.

It will also be understood that when an element such as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, may be used herein for ease of description to describe one element's or feature's relationship to another element(s) or feature(s) as illustrated in the FIGs. It will be understood that the spatially relative terms are intended to encompass different orientations of the device in use or operation in addition to the orientation depicted in the FIGs. For example, if the device in the FIGs. is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly. In addition, it will also be understood that when a layer is referred to as being “between” two layers, it can be the only layer between the two layers, or one or more intervening layers may also be present.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present concept.

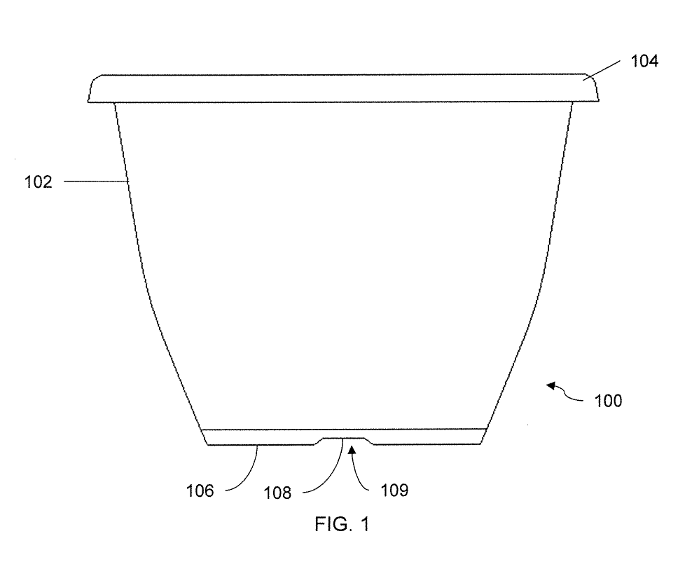

Referring now to the drawings in which like numerals represent the same or similar elements and initially to FIG. 1, a side view of planter 100 is shown in accordance with the present principles.

According to aspects of the present embodiment, planter 100 may have a base 106 with a sidewall 104 upwardly extending therefrom. The base 106 may be, e.g., circular, but may also be square, rectangular, elliptical or any other suitable shape. The sidewall 102 may contact edges of the base 106, preferably all around the perimeter of the base 106. In this way, the sidewall 102 may provide a sealed connection to the base 106 such that water and soil may be retained therein.

The sidewall 102 may take any suitable shape for retaining a plant and soil. According to the present embodiments, the sidewall 102 may take a shape that facilitates stacking of multiple planters 100. For example, the sidewall 102 may be circular in cross section and extending vertically from the base 106 to a top circular rim 104, with the radius of the circular cross section increasing in size towards the circular rim 104. Alternatively, the sidewall 102 may be vertical with a circular cross-section, thus forming a cylinder extending upwards from a circular base 106, or it may include multiple flat sidewalls, thus forming a box shape, or the shape of the cross section may change with height. Other base 106 and sidewall 102 configurations are contemplated.

Additionally, the base 106 may include an indented portion 108. The indented portion 108 may consequently form a channel 109 beneath the base 106 for the free flow of water underneath the planter.

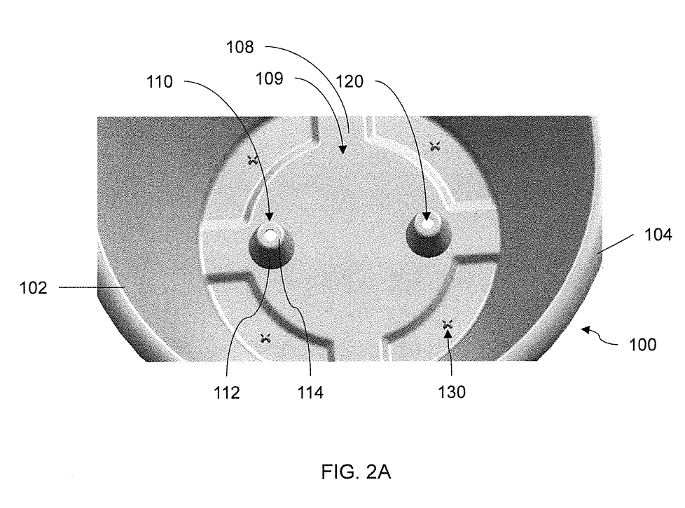

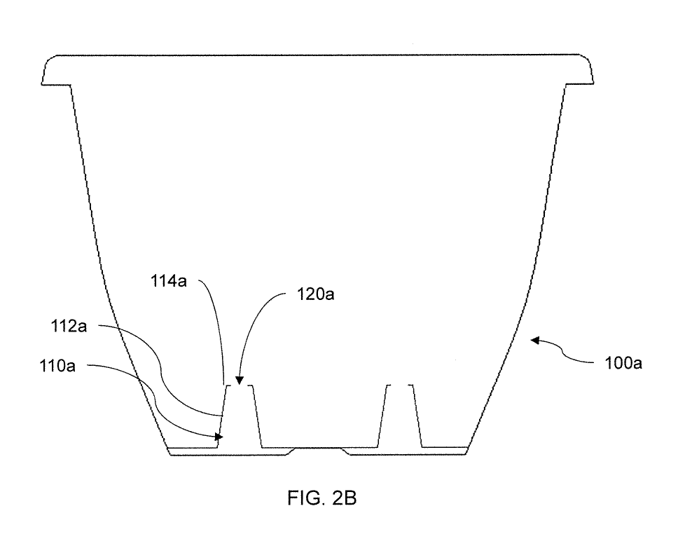

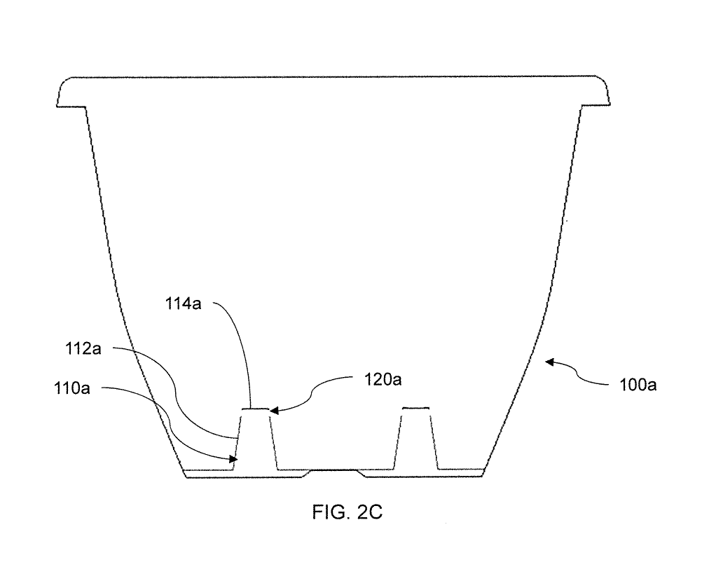

Referring now to FIGS. 2A-C, views of the planter 100 according to another embodiment of the present invention is illustratively depicted.

According to aspects of the present invention, the base 106 may include drain posts 110. There may be, e.g., two drain posts 110, or there may be any suitable number of drain posts 110. The drain posts 110 may be formed on the base 106 and have sidewalls 112 that extend substantially vertically upwards (e.g., between 60 and 90 degrees with respect to a horizontal plane). The drain posts 110 extend to a desired height to ensure that a desired volume of water is retained below the tops 114 of the drain posts 110. The volume may be chosen according to a variety of factors including how often the reservoir will be refilled. The drain posts 110 may take any suitable cross sectional shape, such as, e.g., circular. The drain posts 110 may taper towards the top to facilitate stacking, or the drain posts 110 may maintain a constant cross sectional area throughout the height of the drain posts 110. Moreover, according to aspects of the present embodiment, the drain posts 110 may be integrally formed with the base 106. However, the drain posts 110 may include a seal connection configuration to the base 106 through any suitable means, e.g. pressure seal, polymeric seal, fastened by threads and sealed with a sealant, etc.

According to aspects of the present embodiment, a top 114 of the drain posts 110 may include a flat surface having a drain hole 120 in the center thereof, as depicted in FIGS. 2A and 2B. The drain hole 120 may be sized to ensure that any excess water will drain out of planter before the water causes any damage to the plant. Alternatively, as depicted in FIG. 2C, the top 114 may taper directly to an aperture, or may include perforations, a mesh, one or more slits, or any other suitable opening through which water may pass. One possible embodiment may include drain posts 110a having a flat top 114a, and rather than a drain hole 120, a solid top surface 114a with drain openings 120a in the sidewall 112a below the solid top surface 114a.

The drain posts 110 may lead to the indented portion 108 in the base 106 of the planter. The indented portion 108 may be a portion of the base 106 that is raised above a surface on which the planter rests. The indented portion 108 may of such a shape as to allow water to drain from the drain posts 110 and escape from beneath the planter through channel 109 to facilitate the outflow of excess water being drained from the planter. In this way, the planter 100 according to aspects of the present embodiment, avoids an excess of water that may be damaging to a plant.

Additionally, the base 106 may include one or more locating projections 130 (for example, four). The locating projections 130 may be, e.g., cross-shaped projections; however other shapes are contemplated (for example, cylinders, pyramids, cones, tetrahedons, etc.). The locating projections 130 according to the present embodiment extend vertically with a top portion that tapers to a point. The taper of the locating projections 130 facilitate the insertion of the locating projections 130 into a mating locating hole, thus ensuring the proper locating and fitting of a part inserted into the planter, such as a removable riser as discussed below.

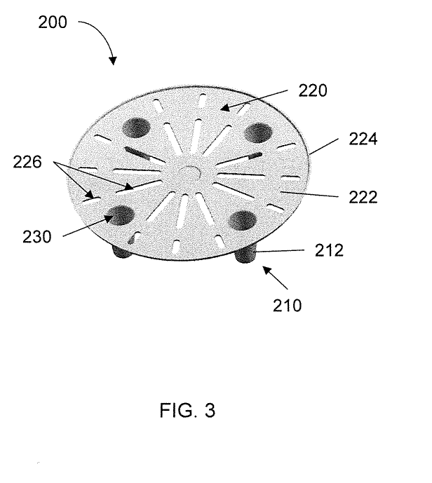

Referring now to FIGS. 3-5, various views of a removable riser 200 according to another embodiment of the present invention are illustratively depicted.

A removable riser 200 may be inserted into a planter such as planter 100. The removable riser 200 may include a plate 220 and support columns 210. The plate 220 includes a top surface 222 and a bottom surface 228, with the support columns 210 extending from the bottom surface 228. The plate 220, therefore, acts as a platform held at a given height by the support columns 210, which may be integrally formed thereon, but may also be attached by any suitable means. The plate may be, e.g., disc shaped. However, the plate 220 may take on other shapes, such as square, oval, triangular, or any other suitable shape to conform to the interior of a planter. The support columns 210 may include holes 216 at the ends thereof. According to aspects of embodiments of the present invention, these holes 216 may be used for water draining purposes, or in some embodiments, for interfacing with locating projections, such as those described in the planter 100 described above.

According to aspects of the embodiment, the support columns 210 are hollow, resulting in a cavity 230 on the interior of the support columns 210 accessible from the top surface 222 of the plate 220. Once inserted into a planter, the plate 220 is configured to support a plant and soil mixture over a reservoir. The plant will rest on a top surface 222 of the plate 220 and the soil mixture may occupy the cavities 230 of the support columns 210. By filling the cavities 230 with soil, the soil may act like a wick that can absorb moisture from the reservoir and transport the moisture via capillary action up into the bulk of the soil mixture and into contact with roots of the plant. Such a configuration results in a self-watering system whereby the soil and the plant extract water from the reservoir in the appropriate quantities for plant growth. Thus, the system ensures enough water is provided to the plant without overwatering the plant.

To further facilitate the operation of the planter according to aspects of the present embodiment, the plate 220 and the support columns 210 may each have openings, 226 and 218 respectively, through which water may pass. The column openings 218 enable water to enter the cavities 230 of the support columns 210 through a sidewall 212 of the support columns 210 from the reservoir. These column openings 218 thus bring the soil into contact with the water of the reservoir, enabling the wicking function of the soil. The column openings 218 may be of a shape such as, e.g., slits from the base to the column end 214, according to one aspect of the present embodiment.

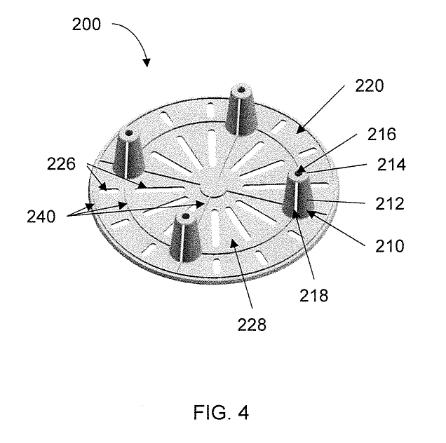

However, other configurations are possible, such as a single hole or a series of holes aligned vertically with either constant size or size varying with height, perforations, a mesh or screen, slits aligned horizontally, or any suitable opening for allowing water to enter the cavity 230. The column openings 218 may all be facing in a common direction, such as the direction depicted in FIG. 4. However, the column openings 218 may each face towards a center of the riser 200, or away from the center of the riser 200. Or the column openings 218 may each face tangential to a radius from the center of the riser 200 in a common direction (i.e. counterclockwise or clockwise).

The plate openings 226 may extend through the plate 220 from the front surface 222 through the back surface 228. The plate openings 226 may, therefore, allow for water to pass therethrough. Such a configuration may enable water poured into the soil of the plant to drain through the bottom of the soil mixture, through the plate 220, and into the reservoir. As a result, the removable riser 200 ensures that excess water in the soil can drain from the soil into the reservoir, thus preventing overwatering. As discussed above, a moisture level in the soil may then be maintained through the capillary action of the soil in the cavities 230 of the support columns 210 absorbing the water in the reservoir. Thus, a self-watering and self-regulating system is established in the planter due to the presence of a removable riser 200 such as the one described in the present embodiment.

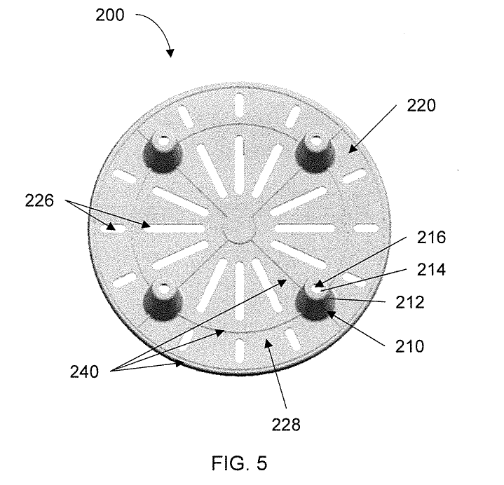

Additionally, the plate openings 226 may be configured to allow roots of a plate to pass therethrough. For example, the plate openings 226 may be slits extending radially outward, as depicted in FIG. 5. However, other configurations are contemplated. The plate openings 226, for example, may also be circular and randomly distributed, or distributed in a ring-like pattern, or in a rectangular, grid-like pattern, with either constant size or varying with distance from a center of the plate 220. The plate openings 226 may be linear slits, or they may be curved or zig-zagged. The plate openings 226 may also include a relatively large center hole to allow for a large taproot to pass through to the water below. Additionally, the plate openings 226 may be configured to not allow roots to pass through. The plate openings 226 may, therefore, take any of the forms described above, but with openings that are too small for a root to fit through, or the plate openings 226 may include a mesh screen or fabric supported by the support columns 210 and ribs 240. Combinations of the above plate opening 226 configurations are also contemplated.

The removable riser 200 may also include additional structural support to better support the weight of a plant and soil, particularly in scenarios involving large plants. According to aspects of embodiments of the present invention, the support may take the form of the ribs 240. The ribs 240 are depicted as being on the bottom surface 228 of the plate 220, however they may alternatively be on the top surface 222 or on both the top surface 222 and bottom surface 228. In one possible embodiment, the ribs 240 may include a series of radial ribs as well as a plurality of linear ribs. These ribs 240 may bolster the rigidity of the plate 220 and prevent bending or cracking under the weight of large plants and soil volumes.

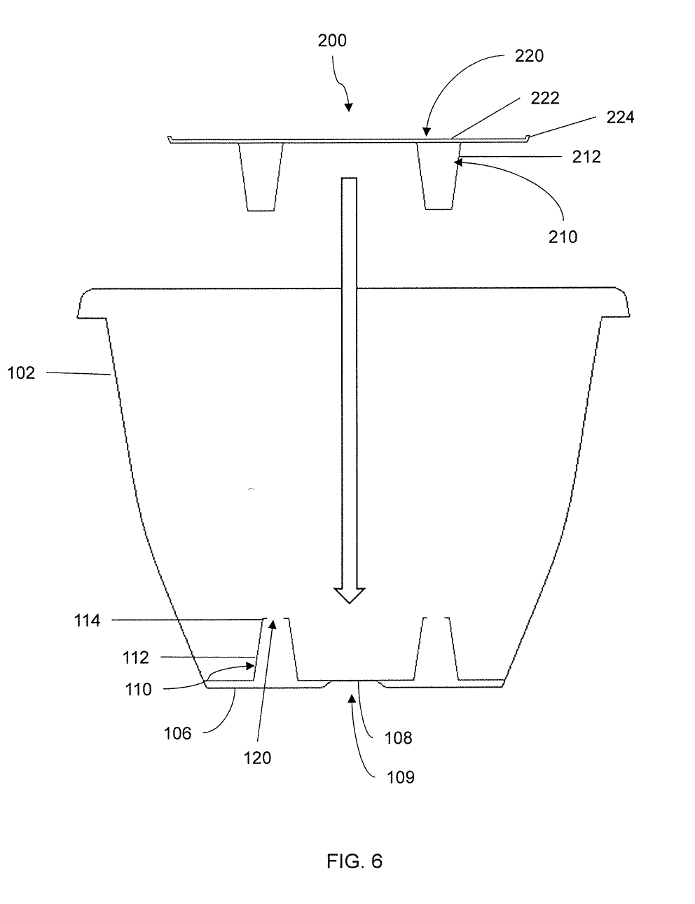

Referring now to FIG. 6, a partial cross section view of a planter 100 with removable riser 200 in accordance with another embodiment of present invention is illustratively depicted.

According to aspects of embodiments of the present invention, the removable riser 200 may be inserted into the bottom of a planter 100 such that the support columns 210 support the plate 222 at a desired height above the base 106 of the planter 100. The height of the plate 222 may be such that the plate is some difference in height above the top surface 114 of the drain posts 110 (for example, about 3 mm). The difference in height enables space to accommodate excess water that can drain from the drain hole 120 in the top of the drain posts 114 without passing through the plate openings 226 into the soil. As a result, the reservoir can accommodate a desired water level that will drain before it rises to a level of the soil. Accordingly, excess water in the soil is prevented, thus avoiding damage to the plant.

According to aspects of the invention, the plate 220 may further include a rim 224. The rim 224 may be configured to uniformly contact the interior surface of the sidewall 102 of the planter 100. The rim 224 is thus operable to prevent soil from falling into the reservoir through gaps between the plate 220 and the sidewall 102 of the planter 100. Accordingly, the plate 220 may better support the plant and the soil mixture, ensuring a proper seating of the plant with a lower risk of soil erosion into the reservoir.

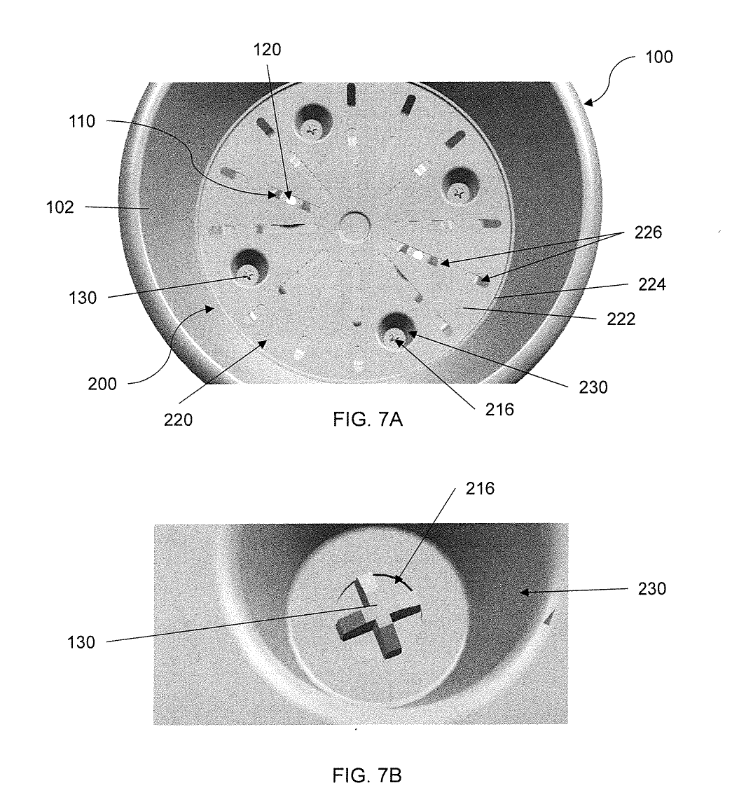

Referring now to FIGS. 7A and 7B, partial top views of the removable riser 200 inserted into the planter 100 according to another embodiment are illustratively depicted.

According to aspects of an embodiment of the invention, the planter 100 may have locating projections 130 formed on the base 106, and the removable riser 200 may have end holes 216 formed on the ends of the support columns 210. When the removable riser 200 is inserted into the planter 100, the locating projections 130 may be aligned and brought into mating contact with the end holes 216. By aligning the locating projections 130 with the end holes 216, the removable riser 200 may be secured in an optimal seating arrangement within the planter 100.

According to aspects of an embodiment of the invention, an optimal seating arrangement for the removable riser 200 may include a rotational orientation based on the shape of the walls. For example, if the sidewalls 102 of the planter are uneven or non-uniform in shape, the locating projections 130 and corresponding end holes 216 may ensure a proper and effective rotational orientation. Such a desired orientation may include, for example, an orientation where the drain holes 120 align with plate openings 226. Such an arrangement may provide improved drainage by reducing the risk of blocking the drain holes 120, whether by deformation of the plate or soil and other objects being caught between the tops of the drain posts 110 and the plate 220.

Moreover, by inserting the locating projections 130 into the end holes 216, the orientation of the removable riser 200 is fixed, preventing any inadvertent movement of the removable riser 200 that may cause unwanted shifting or erosion of the soil. According to aspects of an embodiment, the locating projections 130 and end holes 216 may be switched, such that the locating projections 130 are at the ends of the support columns 210, while the end holes 216 include indented portion 108 in the base 106 of the planter 100 corresponding to the shape of the locating projections 130. Additionally, the locating projections 130 may be smaller than the end holes 216, allowing for a small amount of relative movement. However, in other embodiments, the locating projections 130 may be substantially equal in size to the end holes 216, or sized so as to provide a snap fit or friction fit with the end holes 216 to secure the removable insert to the bottom of the planter 100.

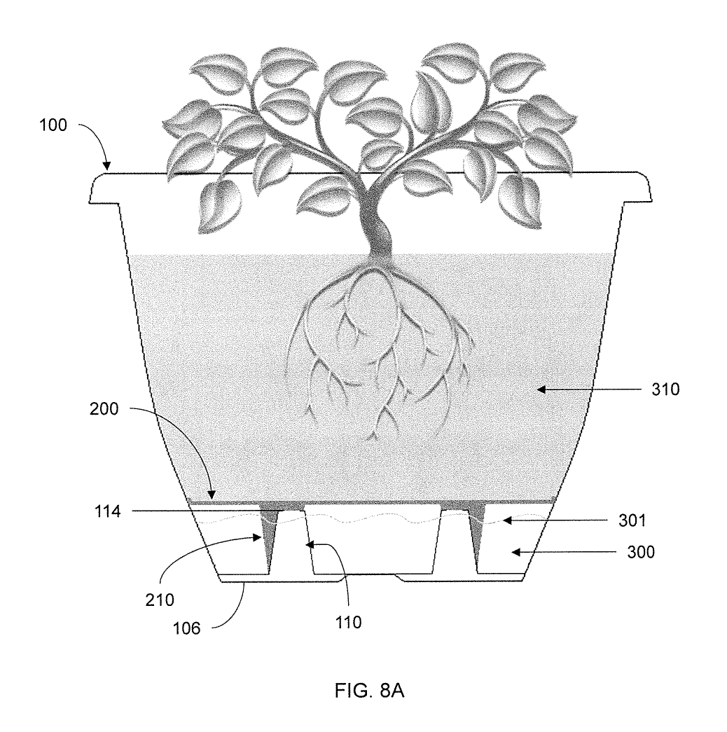

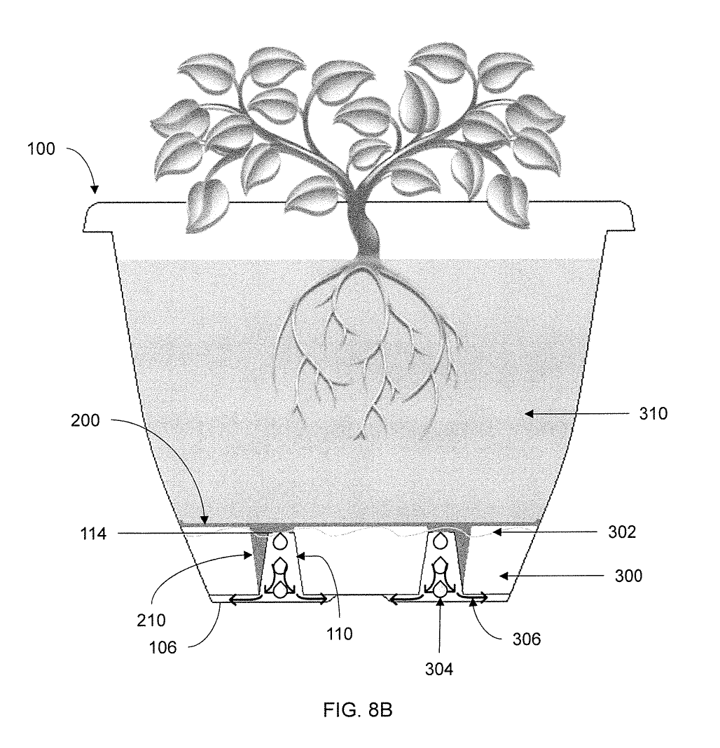

Referring now to FIGS. 8A and 8B, cross-sectional views of the removable riser 200 inserted into the planter 100 according to another embodiment are illustratively depicted.

In operation, a self-watering planter including a planter 100 and a removable riser 200, may contain soil 310 and water in a reservoir 300. The water in the reservoir 300 may rise to a level 301 below the tops 114 of the drain posts 110 as depicted in FIG. 8A. In this situation, the soil 310 may extend into cavities within support columns 210 of the removable riser 200, down into the reservoir 300 containing the water. Because the drain posts 110 are shorter than the support columns 210, the riser 200 is situated above the water level 301. As a result, only the soil 310 in the support columns 210 is in contact with the water, and therefore, water absorption in the soil 310 is controlled by the soil 310 itself.

As a result of this configuration, even when the water reaches an overfill level 302 (as depicted in FIG. 8B), the removable riser 200 is still situated about the overfill level 302. Once the water rises to an overfill level 302 above the tops 114 of the drain posts 110, water drains from the reservoir 300 through drain posts 110 by drain flow 304. As a result, even in an overfilled state, the overfill level 302 is still below the removable riser 200. Thus, controlled self-watering from the absorption of water by the soil 310 in the support columns 210 is maintained.

Due to the indented portion 108 of the base 106 forming the channel 109, water from the drain flow 304 may flow underneath the planter 100 along flow path 306 to an exterior of the planter 100. Accordingly, planter 100 may continually drain water as long as the water is at an overfill level 302.

Having described preferred embodiments for planters with elevated internal portion and water preservation features (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is desired to be protected by Letters Patent is set forth.

What is claimed is:

1. A planter, comprising:
a base including a raised portion to form a channel beneath the base;
at least one substantially vertical planter sidewall formed with the base;
at least one drain post integrally formed on the base and extending substantially vertically upwards with a drain opening at the top of each of the at least one drain post in communication with the channel; and
a removable riser, wherein the removable riser includes;
a plate supported by a plurality of hollow support columns wherein the hollow support columns are longer than the at least one drain post forming a reservoir beneath the plate; and
the hollow support columns each including at least one opening in a column sidewall.

2. The planter of claim 1, wherein the base includes a plurality of projections extending upwardly from the base and corresponding to a hole in the end of at least one of the plurality of hollow support columns.

3. The planter of claim 2, wherein the projections insert into the hole at the at least one of each of the plurality of hollow support columns.

4. The planter of claim 1, wherein each of the hollow support columns is configured to accommodate soil in contact with water for transporting water above the plate by capillary action.

5. The planter of claim 1, wherein the at least one drain post is wider at the base and narrows towards a top of the at least one drain post, and the planter is narrower at a base and wider at a top of the planter such that the planter is stackable with other planters.

6. The planter of claim 1, wherein the plate includes a rim for maintaining uniform contact between the plate and the at least one planter sidewall.

7. The planter of claim 1, wherein the plate includes a plurality of plate openings for water to communicate.

8. The planter of claim 7, wherein each drain opening of the at least one drain post is aligned with at least one of the plurality of plate openings.

9. The planter of claim 1, wherein the plate includes support ribs for strengthening the plate.

10. The planter of claim 1, wherein the hollow support columns are about three millimeters longer than the at least one drain post.

11. The planter of claim 1, wherein the at least one opening in the column sidewall includes a single slit-like opening along an entire length of each of the plurality of hollow support columns.

12. A stackable planter, comprising:
a base including a raised portion to form a channel beneath the base;
at least one substantially vertical planter sidewall formed with the base;
a plurality of drain posts integrally formed on the base and extending substantially vertically upwards with a drain opening at the top of each of the drain posts in communication with the channel;
a plurality of projections extending upwardly from the base; and
a removable riser, wherein the removable riser includes;
a plate supported by a plurality of hollow support columns wherein the hollow support columns are longer than the plurality of drain posts forming a reservoir beneath the plate;
each of the hollow support columns including a locator opening for mating contact with the plurality of projections; and
each of the hollow support columns including a slit-like opening in a column sidewall.

13. The planter of claim 12, wherein each of the projections insert into the locator opening of one of the plurality of hollow support columns.

14. The planter of claim 12, wherein each of the hollow support columns is configured to accommodate soil in contact with water for transporting water above the plate by capillary action.

15. The planter of claim 12, wherein the plate includes a rim for maintaining uniform contact between the plate and the at least one planter sidewall.

16. The planter of claim 12, wherein the plate includes a plurality of plate openings for water to communicate.

17. The planter of claim 16, wherein each drain opening of the at least one drain post is aligned with at least one of the plurality of plate openings.

18. The planter of claim 12, wherein the plate includes support ribs for strengthening the plate.

19. The planter of claim 12, wherein the hollow support columns are about three millimeters longer than the at least one drain post.

20. A method for plant watering, comprising:
providing a planter with;
a base including a raised portion to form a channel beneath the base;
at least one substantially vertical planter sidewall formed with the base;
at least one drain post integrally formed on the base and extending substantially vertically upwards with a drain opening at the top of each of the at least one drain post in communication with the channel; and
a removable riser, wherein the removable riser includes;
a plate supported by a plurality of hollow support columns wherein the hollow support columns are longer than the at least one drain post forming a reservoir beneath the plate; and
the hollow support columns each including at least one opening in a column sidewall;
supporting a plant and a soil mixture on a top portion of the removable riser and in the hollow support columns; and
storing water in the reservoir such that the soil mixture in the plurality of hollow support columns absorbs the water and transports it by capillary action to the plant.
